(19) United States
(12) Patent Application Publication
(10) Pub. No.: US 2026/0281017 A1
(43) Pub. Date: Sep. 17, 2026

(54) NETWORK SECURITY TECHNIQUES USING LANGUAGE MODELS

(71) Applicant: Cisco Technology, Inc., San Jose, CA (US)

(72) Inventors: Prashanth Arun, San Jose, CA (US); Mark Joseph Rogers, Brookline, MA (US); Santwana Cheemalamarri, Bengaluru (IN)

(21) Appl. No.: 19/082,730

(22) Filed: Mar. 18, 2025

Related U.S. Application Data
(60) Provisional application No. 63/771,402, filed on Mar. 13, 2025.

(51) Int. Cl. H04L 43/062; H04L 9/40; H04L 41/16

(52) U.S. Cl. CPC H04L 43/062; H04L 41/16; H04L 63/0428

(57) ABSTRACT

This disclosure describes techniques for generating prediction(s) based on network traffic data associated with one or more devices in a computer network. In some cases, an example system is configured to process network traffic data using a language model to generate one or more outputs. The system may process the one or more outputs using a prediction model to predict a feature associated with the network traffic data. The system may perform a responsive action based on the predicted feature.

### CROSS-REFERENCES TO RELATED APPLICATION(S)

The present application claims priority to the U.S. Provisional Patent Application No. 63/771,402, entitled “Network Security Techniques using Language Models and Preprocessed Network Traffic data” filed on Mar. 13, 2025, which is incorporated by reference herein in its entirety and for all purposes.

### TECHNICAL FIELD

The present disclosure relates generally to network security, and more specifically to network security techniques using language models.

### BACKGROUND

Computer networks are often subject to various security threats, such as unauthorized access, malware, and denial-of-service attacks. These security threats can compromise the confidentiality, integrity, and availability of data and resources. Traditional security measures, such as firewalls and intrusion detection systems, may not be sufficient to protect against all security threats. For example, traditional security measures may rely on predefined rules and signatures that can be evaded by new and evolving threats. As another example, traditional security measures may generate large numbers of false positives, which can overwhelm security analysts and make it difficult to identify real threats.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 provides an example architecture for generating predictions based on network traffic data.

FIG. 2 is a flowchart diagram of an example process for preprocessing network traffic data using decryption-based techniques.

FIG. 3 is a flowchart diagram of an example process for preprocessing network traffic data using an image data removal operation.

FIG. 4 is a flowchart diagram of an example process for training the language model.

FIG. 5 is a flowchart diagram of an example process for training the language model.

FIG. 6 is an example process for training a language model based on preprocessed network traffic data.

FIG. 7 is a flowchart diagram of an example process for generating predictions based on preprocessed network traffic data.

FIG. 8 shows an example computer architecture for a computer capable of executing program components for implementing the functionality described above.

### DESCRIPTION OF EXAMPLE EMBODIMENTS

### Overview

This disclosure describes techniques for generation prediction(s) based on network traffic data associated with one or more devices in a computer network. In some cases, an example system is configured to process network traffic data using a language model to generate one or more outputs. The system may process the one or more outputs using a prediction model to predict a feature associated with the network traffic data. The system may perform a responsive action based on the predicted feature.

In some cases, the techniques described herein relate to a method including receiving first network traffic data associated with a first computing device. The method may further include determining a category associated with the first network traffic data, wherein the category represents at least one of a protocol or a content type. The method may further include determining first preprocessed data based on the first network traffic data and a preprocessing operation, wherein the preprocessing operation is determined based on the category. The method may further include training a machine learning model based on the first preprocessed data and a language modeling task. The method may further include providing the machine learning model to a system, wherein the system is configured to determine a feature associated with second network traffic data based on the machine learning model.

### Example Embodiments

This disclosure describes techniques for generating predictions based on network traffic data associated with one or more computing devices in a computer network. In some cases, an example system is configured to process network traffic data using a language model to generate one or more outputs. The system may process the one or more outputs using a prediction model to predict a feature associated with the network traffic data. The system may perform a responsive action based on the predicted feature. The techniques described herein may be executed by a firewall (e.g., web application firewall (WAF), a network firewall, a next-generation firewall (NGFW), and/or the like), an intrusion detection/prevention system (IDS/IPS), a network monitoring tool, a load balancer, and/or the like.

In some cases, the techniques described herein relate to processing network traffic data using a language model (e.g., a large language model) trained based on network traffic data. For example, in some cases, an example system is configured to: (i) process network traffic data based on one or more preprocessing operations (e.g., one or more preprocessing operations determined and/or selected based on a network protocol and/or content type associated with the network traffic data) to generate preprocessed network traffic data, (ii) process the preprocessed network traffic data using a language model to determine an encoded representation of the preprocessed network traffic data, and/or (iii) process the encoded representation using a prediction model to generate a predicted feature. The predicted feature may represent a prediction about whether the network traffic data represents a malicious behavior (e.g., as described below). Alternatively, or additionally, the predicted feature may relate to other network characteristics, such as application performance, network congestion, or user behavior.

As another example, in some cases, a system is configured to: (i) process network traffic data based on one or more preprocessing operations (e.g., one or more preprocessing operations determined and/or selected based on a network protocol and/or content type associated with the network traffic data) to generate preprocessed network traffic data, and/or (ii) process the preprocessed network traffic data using a generative language model to determine a generative output. The generative output may represent a predicted feature represented by the network traffic data, an explanation of the network traffic data, and/or the like. The predicted feature may represent a prediction about whether the network traffic data represents a malicious behavior (e.g., as described below).

A malicious behavior may refer to a set of actions performed by a device and/or software application that violate one or more security policies associated with a monitored device, compromise the integrity of the monitored device, comprise the integrity of data maintained by the monitored device, comprises availability of one or more services provided by the monitored device, and/or the like. In some cases, a malicious behavior includes at least one of an unauthorized access behavior (e.g., password cracking), a data breach behavior (e.g., sensitive data exfiltration), a malware infection behavior, denial-of-service (DOS) attack behavior, a spoofing behavior, a phishing behavior, an injection attack behavior (e.g., a structured query language (SQL) injection attack, a cross-site scripting attack, a Lightweight Directory Access Protocol (LDAP) injection attack, and/or the like), a data manipulation behavior, and/or the like.

Accordingly, as described above, the techniques described herein may relate to a model architecture (e.g., a machine learning architecture) including a language model and/or a prediction model. The language model may be configured to process preprocessed network traffic data to generate one or more outputs (e.g., an encoded representation and/or an “embedding,” a generative output, and/or the like). The language model may be a model (e.g., a transformer model) with an attention-based mechanism (e.g., a self-attention mechanism, a cross-attention mechanism, and/or the like). In some cases, the language model is trained using one or more language modeling tasks (e.g., a missing token detection task, a next sentence prediction task, a masked language modeling task, and/or the like). The language model may receive as input the preprocessed network traffic data (e.g., a sequence of tokens representing the preprocessed network traffic data) and generate as output a representation of the input data (e.g., a vector representation of the input data). The language model may include one or more layers (e.g., transformer layers). Each layer may include an attention mechanism (e.g., a multi-head attention mechanism) and a feed-forward network. The attention mechanism may compute attention weights based on the input data. The feed-forward network may process the output of the attention mechanism.

In some cases, instead of providing raw network traffic data as inputs to a language model, the network traffic data may first be preprocessed before input to the language model. The objective behind these preprocessing operation(s) may be to enhance the semantic meaning of the network traffic data for the language model. Example or preprocessing operations and/or example techniques for selecting and/or determining preprocessing operations based on a category (e.g., a protocol and/or content type) associated with network traffic data are described below. However, a person of ordinary skill in the relevant technology will recognize that preprocessing network traffic data may include: (i) executing preprocessing operations other than and/or in addition to the preprocessing operations described herein, and/or (ii) preprocessing operations may be selected and/or techniques based on factors other than protocol and/or content type, and/or using techniques other than the techniques described herein.

For example, in some cases, performing preprocessing operations may include decrypting at least a portion of the contents of the network traffic data. For example, when the network traffic data includes one or more encrypted packets (e.g., one or more Hypertext Transfer Protocol Secure (HTTPS) packets; one or more packets encrypted using an encryption technique, such as using a Transport Layer Security (TLS) and/or Secure Sockets Layer (SSL) encryption technique; and/or the like), the system may determine to decrypt at least a portion of the encrypted packet(s). Decrypting a network packet may be based on a session key associated with the encrypted packet. The session key may be obtained through a key exchange process. The decrypted portion of the packet may include the payload of the packet. For HTTPS traffic, this might involve decrypting the application data.

As another example, in some cases, performing preprocessing operations may include removing image data (e.g., base64-encoded image data) and/or random sequence data (e.g., image data represented using random sequence(s), such as using base64-encoded random sequence(s)) from the network traffic data. For example, when the network traffic data includes Hyper-Text Markup Language (HTML) data, the system may remove image data and/or random sequence data from the HTML data. The objective behind this preprocessing operation may be rooted in the lack of semantic significance of image data (e.g., binary image data) and/or random sequence data.

As another example, in some cases, performing preprocessing operations may include removing unique identifiers and/or replacing unique identifiers with default tokens. For example, when the network traffic data includes an authentication request with one or more authentication tokens (e.g., an authentication key, a username and a password, and/or the like), the system may remove such token(s) and/or replace these token(s) with default token(s) (e.g., with default token(s) such as “USER_ENTERED_AUTHENTICATION_KEY”, “USER_ENTERED_USERNAME”, “USER_ENTERED_PASSWORD”, and/or the like). The objective behind this preprocessing operation may be rooted in the lack of semantic significance of unique identifiers, which may make it difficult for the language model and/or for the prediction model processing encoded representation(s) generated by the language model to infer similarities between similar action patterns across different sessions and/or examples.

As another example, in some cases, performing preprocessing operations may include normalizing and/or standardizing data within the network traffic data. For example, when the network traffic data includes numerical values (e.g., port numbers, Internet Protocol (IP) addresses, packet sizes, timestamps, and/or the like), the system may normalize and/or standardize such numerical values. Normalizing numerical values may include scaling the numerical values to a specific range (e.g., a range between 0 and 1). Standardizing numerical values may include transforming the numerical values such that they have a mean of zero and a standard deviation of one. The objective behind this preprocessing operation may be rooted in improving the performance of the language model by ensuring that numerical features are on a similar scale.

As another example, in some cases, performing preprocessing operations may include converting data within the network traffic data to a consistent format. For example, when the network traffic data includes different data types (e.g., integer, float, string, and/or the like), the system may convert the data to a consistent data type (e.g., to a string type). For example, IP addresses may be represented as strings. In some cases, timestamps may be converted to a standard format (e.g., into a YYYYMMDD-HH:MM:SS format).

As another example, in some cases, performing preprocessing operations may include removing some lower-level header data from the network traffic data. For example, when the network traffic data includes network packets (e.g., Transmission Control Protocol (TCP)/IP packets), the system may remove lower-level headers, such as the Media Access Control (MAC) header, the physical layer header, and/or the like. The objective behind this preprocessing operation may be rooted in the fact that such lower-level headers may not contain information that are semantically relevant to a prediction task being performed (e.g., malicious behavior detection) and may increase the complexity of the data processed by the language model. In some cases, the removed header data may relate to the physical transmission of the data and not the content and/or intent of the communication.

As another example, in some cases, performing preprocessing operations may include removing header data irrelevant to attack detection from the network traffic data. For example, when the network traffic data includes TCP/IP network packets, the system may remove certain fields from the IP header (e.g., fragmentation offset, time to live (TTL), and/or the like) and/or the TCP header (e.g., sequence numbers, acknowledgement numbers, flags related to connection establishment and tear-down, window size, and/or the like). The objective behind this preprocessing operation may be rooted in the fact that such header fields may not contain information that are semantically relevant to attack detection.

As another example, in some cases, performing preprocessing operations may include decoding and/or parsing encoded data within the network traffic data. For example, when the network traffic data includes uniform resource locator (URL) encoded data, the system may decode the URL-encoded data. As another example, when the network traffic data includes data encoded using base64 encoding, the system may decode the base64-encoded data. As another example, when the network traffic data represents a structured query (e.g., an SQL query), the system may parse the query to identify keywords, table names, column names, and/or other elements of the query.

As another example, in some cases, performing preprocessing operations may include removing and/or masking personally identifiable information (PII) from the network traffic data. For example, when the network traffic data includes PII (e.g., names, email addresses, phone numbers, credit card numbers, and/or the like), the system may remove or mask such PII. Masking PII may include replacing PII with placeholder values (e.g., replacing a name with “REDACTED_NAME”).

As another example, in some cases, performing preprocessing operations may include tokenizing the network traffic data. For example, the system may segment the network traffic data into individual tokens. For example, a uniform resource locator (URL) may be broken down into its constituent parts (e.g., protocol, domain, path, query parameters). As another example, a command may be broken down into keywords and/or arguments.

In some cases, after network traffic data is preprocessed, the preprocessed network traffic data is processed by a language model to generate an encoded representation. The encoded representation may then be processed by a prediction model to generate a predicted feature associated with the network traffic data, such as a predicted feature representing whether the network traffic data represents a malicious activity pattern. In some cases, the prediction model is a trained machine learning model (e.g., including one or more fully-connected neural network layers) configured to receive as input the encoded representation generated by the language model. The prediction model may be a classification model (e.g., a logistic regression model, a support vector machine (SVM) model, a decision tree model, a random forest model, a gradient boosting model, a neural network model, and/or the like). The prediction model may be trained using labeled data, where each training data sample includes an encoded representation of particular network traffic data (e.g., as generated by the language model) and a corresponding label indicating a ground-truth feature associated with the network traffic data (e.g., indicating whether the network traffic data represents a malicious activity pattern).

In some cases, the prediction model is configured to generate a probability score representing the likelihood that the network traffic data represents a malicious activity pattern. The probability score may be a value between 0 and 1, where a higher score indicates a higher likelihood of malicious activity. In some cases, the probability score is compared to a threshold value. If the probability score exceeds the threshold value, the network traffic data may be flagged as representing a malicious activity pattern. The threshold value may be a fixed value or a dynamically adjusted value. In some cases, the prediction model is configured to generate a categorical output indicating whether the network traffic data represents a malicious activity pattern. The categorical output may be a binary value (e.g., 0 or 1, true or false) or a multi-class value (e.g., representing different types of malicious activity). For example, the prediction model may be trained to predict the specific type of malicious activity represented by the network traffic data (e.g., denial-of-service attack, SQL injection attack, cross-site scripting attack, and/or the like).

In some cases, the language model and the prediction model are jointly trained. For example, in some cases, training the language model includes: (i) training the language model based on the preprocessed network traffic data and in accordance with a language modeling task, (ii) after the language modeling training in (i), preprocessing the network traffic data associated with one or more training sample(s), encoding the preprocessed network traffic data using the language model, and processing the encoded representations using the prediction model to generate predicted feature(s) associated with the training sample(s), (iii) determining a loss based on a deviation between the predicted feature(s) and the labeled feature(s) represented by the training sample(s), and/or (iv) updating the parameters of at least one of the language model or the prediction model based on the determined loss.

For example, the system may first train the language model using a network traffic packet and using a missing word detection. This “language modeling” training may include: (i) receiving the network traffic packet, (ii) preprocessing the network traffic packet, (iii) masking a subset (e.g., one or more tokens) of the preprocessed packet, (iv) processing the masked packet using the language model to predict the masked subset, (v) determining a loss (e.g., a cross-entropy loss) based on a deviation between the predicted masked subset (e.g., one or more predicted tokens) and the actual masked subset, and/or (vi) training the language model based on the determined loss. After the language modeling training, the system may train the language model and the prediction model jointly using a network traffic packet associated with a labeled feature. For example, the system may: (i) receive the network traffic packet, (ii) preprocess the network traffic packet, (iii) process the preprocessed packet using the language model to generate an encoded representation, (vi) process the encoded representation using the prediction model to generate a predicted feature, (v) determine a loss (e.g., a cross-entropy loss) based on a deviation between the predicted feature and the labeled feature, and/or (vi) train the language model and the prediction model based on the determined loss. In some cases, the system repeats the joint training for multiple network traffic packets associated with labeled features.

As another example, in some cases, the system may train the language model and the prediction model jointly using a plurality of network traffic packets associated with labeled features. For example, the system may: (i) receive the plurality of network traffic packets, (ii) preprocess the plurality of network traffic packets, (iii) process the preprocessed packets using the language model to generate a plurality of encoded representations corresponding to the plurality of packets, (iv) process the plurality of encoded representations using the prediction model to generate a plurality of predicted features, (v) determine a loss (e.g., a cross-entropy loss) based on a deviation between the plurality of predicted features and a plurality of labeled features corresponding to the plurality of packets, and/or (vi) train the language model and the prediction model based on the determined loss.

As another example, in some cases, the system may further fine-tune the language model using reinforcement learning with human feedback. This fine-tuning process may include: (i) receiving a network traffic packet, (ii) preprocessing the network traffic packet, (iii) processing the preprocessed packet using the language model to generate a generative output (e.g., a textual description and/or summary of the network traffic packet), (iv) providing the generative output to a human evaluator, (v) receiving feedback from the human evaluator, (vi) training a feedback prediction model (e.g., a feedforward neural network model) to predict the human evaluator feedback associated with the generative output based on the generative output, (vii) receiving a second network traffic packet, (viii) preprocessing the second network traffic packet, (ix) processing the second preprocessed packet using the language model to generate a second generative output, (x) processing the second generative output using the feedback prediction model to generate a predicted feedback, (xi) determining a loss based on the predicted feedback, and/or (xi) training the language model based on the determined loss.

In some cases, the feedback prediction model may be a classification model (e.g., a logistic regression model, an SVM model, a decision tree model, a random forest model, a gradient boosting model, a neural network model, and/or the like) configured to predict a feedback class associated with the generative output. The feedback class may represent a categorical assessment of the generative output (e.g., “good,” “bad,” “neutral,” and/or the like). In some cases, the feedback prediction model may be a regression model (e.g., a linear regression model, a support vector regression (SVR) model, a decision tree regression model, a random forest regression model, a gradient boosting regression model, a neural network regression model, and/or the like) configured to predict a feedback score associated with the generative output. The feedback score may represent a numerical assessment of the generative output (e.g., a score between 0 and 1, where 0 indicates a poor generative output and 1 indicates an excellent generative output).

As another example, in some cases, training the language model and the prediction model may include: (i) receiving a network traffic packet, (ii) preprocessing the network traffic packet, (iii) processing the preprocessed packet using the language model to generate an encoded representation, (iv) processing the encoded representation using the prediction model to generate a predicted feature, (v) determining a first loss based on a deviation between the predicted feature and a labeled feature associated with the network traffic packet, (vi) determining a second loss based on a language modeling task (e.g., a missing token prediction task) applied to the preprocessed packet, (vii) determining a combined loss based on the first loss and the second loss, and/or (viii) training the language model and the prediction model based on the combined loss.

As another example, in some cases, training the language model and the prediction model may include: (i) receiving a network traffic packet, (ii) preprocessing the network traffic packet, (iii) processing the preprocessed packet using the language model to generate an encoded representation, (iv) processing the encoded representation using the prediction model to generate a predicted feature, (v) determining a first loss based on a deviation between the predicted feature and a labeled feature associated with the network traffic packet, (vi) backpropagating the first loss through the prediction model and the language model to compute gradients with respect to the parameters of the prediction model and the language model, (vii) determining a second loss based on a language modeling task (e.g., a missing token prediction task) applied to the preprocessed packet, (viii) backpropagating the second loss through the language model to compute gradients with respect to the parameters of the language model, (ix) combining the gradients computed in (vi) and (viii) for the parameters of the language model, and/or (x) training the language model and the prediction model based on the combined gradients.

In some cases, the techniques described herein may improve the accuracy of identifying malicious activity patterns and the security of computer systems affected by those identified malicious activity patterns. In some cases, a language model may be able to identify patterns and anomalies in network traffic data that are not easily detectable by traditional rule-based systems. For example, a language model may be able to identify a malicious activity pattern based on the sequence of commands executed by a user, even if those commands are not individually malicious. As another example, a language model may be able to identify a malicious activity pattern based on the timing of network requests, even if those requests are not individually malicious. In some cases, more accurate detection of malicious activity patterns enhances the security of the affected computer systems, for example by enabling performing mitigating (e.g., responsive and/or preventive) actions. Examples of mitigating actions that may be performed in response to identified malicious activity patterns are described below.

In some cases, the techniques described herein may improve the efficiency of processing network traffic data and the security of computer systems associated with processed network traffic data. In some cases, processing network traffic data using a language model may be more computationally efficient than using traditional methods. For example, a language model may be able to identify malicious activity patterns without the need to perform complex feature engineering. As another example, a language model may be able to process large volumes of network traffic data more efficiently than traditional methods. As another example, in some cases, a language model may be able to identify malicious activity patterns in real-time and/or near-real-time, which may allow for more timely mitigation of security threats and thus more secure computer networks. As another example, a language model may be able to identify malicious activity patterns without the need for human intervention, which may reduce the workload of security analysts.

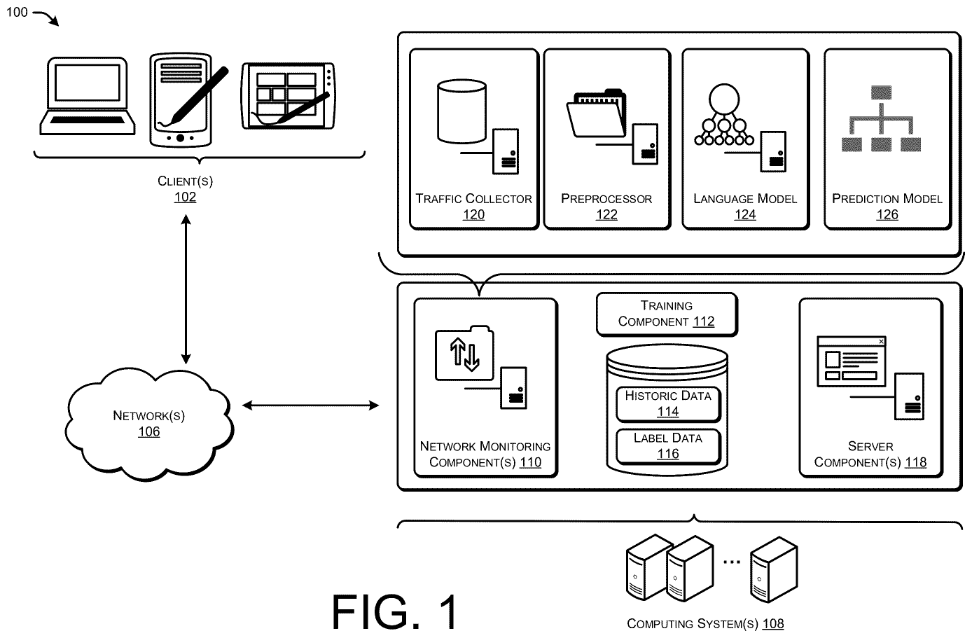

FIG. 1 provides an example architecture 100 for generating predictions based on network traffic data. As depicted in FIG. 1, the architecture 100 may include client(s) 102, network(s) 106, computing system(s) 108, network monitoring component(s) 110, a training component 112, and server component(s) 118. As further depicted in FIG. 1, the network monitoring component(s) 110 may include a traffic collector 120, preprocessor 122, language model 124, and prediction model 126.

The client(s) 102 may include one or more computing devices (e.g., desktop computers, laptop computers, tablet computers, mobile phones, smart devices, Internet of Things (IoT) devices, and/or the like) configured to communicate with each other and/or with other devices over the network(s) 106. Each client 102 may include one or more applications (e.g., web browsers, email clients, file transfer clients, and/or the like) that generate network traffic when communicating with the server component(s) 118 and/or other devices. The client(s) 102 may be assigned to different network segments and/or subnets. The client(s) 102 may run different operating systems and/or have different security configurations.

The network(s) 106 may include one or more computer networks (e.g., a local area network (LAN), a wide area network (WAN), a wireless network, a virtual private network (VPN), the Internet, and/or the like) enabling communication between the client(s) 102 and/or other devices. The network(s) 106 may include one or more network devices (e.g., routers, switches, firewalls, and/or the like) that manage and direct network traffic. The network(s) 106 may use different network protocols (e.g., TCP/IP, User Datagram Protocol (UDP), and/or the like) for communication. The network(s) 106 may be subject to different security threats (e.g., denial-of-service attacks, man-in-the-middle attacks, and/or the like).

The computing system(s) 108 may include one or more server computers (e.g., physical servers, virtual machines, cloud instances, and/or the like) configured to host and execute the network monitoring component(s) 110, the training component 112, and the server component(s) 118. The computing system(s) 108 may be located in a data center, a cloud environment, a server farm, and/or the like.

The server component(s) 118 may include one or more software applications configured to provide one or more services (e.g., web services, an application programming interfaces (API), and/or the like) to the client(s) 102. The server component(s) 118 may be configured to receive network traffic data from the network monitoring component(s) 110. The server component(s) 118 may communicate with other systems and/or services (e.g., security information and event management (SIEM) systems, threat intelligence platforms, and/or the like).

The network monitoring component(s) 110 may include one or more software applications and/or hardware devices (e.g., WAFs, network firewalls, NGFWs, IDS/IPSs, network taps, network sensors, network intrusion detection systems (NIDS), and/or the like) configured to collect network traffic data from the network(s) 106. The network traffic data may include network packets, network flows, network logs, and/or the like. The network monitoring component(s) 110 may be configured to capture network traffic data associated with specific network segments, specific client and/or network devices, and/or specific applications. The network monitoring component(s) 110 may filter network traffic data based on specific criteria (e.g., source IP addresses, destination IP addresses, port numbers, protocols, and/or the like).

In some cases, the network monitoring component(s) 110 may include a firewall configured to monitor (e.g., selectively permit and/or block operations requested by) traffic from the client(s) 102 to the server component(s) 118. For example, in some cases, the firewall may be configured to block network traffic data based on one or more rules. The rules may specify one or more criteria (e.g., source IP address, destination IP address, port number, protocol, and/or the like) and one or more actions to be taken when the criteria are met (e.g., block the traffic, allow the traffic, log the traffic, and/or the like).

In some cases, the components of the network monitoring component(s) 110 (e.g., the traffic collector 120, the preprocessor 122, the language model 124, and the prediction model 126) may be combined to determine that a particular request is malicious and perform a responsive and/or preventive action based on this determination. For example (e.g., as described below), the traffic collector 120 may receive a network traffic packet from the network(s) 106. The preprocessor 122 may preprocess the network traffic packet to generate preprocessed network traffic data. The language model 124 may process the preprocessed network traffic data to generate an encoded representation. The prediction model 126 may process the encoded representation to generate a predicted feature. In some cases, the predicted feature may represent a prediction about whether the network traffic data represents a malicious behavior. If the predicted feature indicates that the network traffic data represents a malicious behavior, the firewall may block the network traffic packet.

In some cases, if the network monitoring component(s) 110 determine that a particular network traffic request represents a malicious activity (e.g., using the language model 124 and the prediction model 126, as described above), the network monitoring component(s) 110 may perform a responsive action. A responsive action may refer to at least one of: (i) blocking the network traffic request, (ii) logging the network traffic request (e.g., in a log file, a database, and/or the like), (iii) generating an alert (e.g., an alert displayed to a user, an alert sent to an SIEM system, and/or the like), (iv) quarantining the source of the network traffic request (e.g., by blocking the IP address of the source, by isolating the source from the network, and/or the like), (v) terminating the network connection associated with the network traffic request, (vi) resetting the network connection associated with the network traffic request, (vii) updating a security policy (e.g., a firewall rule, an IDS/IPS rule, and/or the like) to block future network traffic requests similar to the malicious network traffic request, (viii) initiating an incident response process, and/or the like.

As described above, the network monitoring component(s) 110 may include a traffic collector 120, preprocessor 122, language model 124, and prediction model 126. The traffic collector 120 may be configured to receive network traffic data from the network(s) 106. The traffic collector 120 may store the received network traffic data in a data storage medium. The traffic collector 120 may use one or more traffic collection techniques (e.g., port mirroring, packet sniffing, and/or the like) to collect network traffic data. The traffic collector 120 may aggregate network traffic data from multiple sources.

The preprocessor 122 may be configured to preprocess the network traffic data received from the traffic collector 120. The preprocessor 122 may perform one or more preprocessing operations on the network traffic data (e.g., as described below). A preprocessing operation may include at least one of removing a subset of network traffic data, preserving a subset of network traffic data, and/or transforming (e.g., decrypting) a subset of the network traffic data. The preprocessor 122 may apply different preprocessing operations to particular network traffic data based on the protocol and/or content type associated with the particular network traffic data. The preprocessor 122 may use different techniques (e.g., packet header analysis, deep packet inspection, and/or the like) to identify the protocol and/or content type of the particular network traffic data.

In some cases, the preprocessor 122 may apply different preprocessing operations to different network traffic data sets (e.g., to different network traffic packets) based on the protocols and/or content types associated with those network traffic data sets. In some cases, a protocol associated with a network packet data set may represent an application layer protocol associated with the network packet data set. For example, an application layer protocol may include at least one of HTTP, HTTPS, File Transfer Protocol (FTP), Simple Mail Transfer Protocol (SMTP), Domain Name System (DNS), Telnet, and/or the like. A content type associated with a network packet data set may represent, for example, a content type represented by an HTTP packet header (e.g., a Content-Type field of an HTTP packet header). For example, a content type may include at least one of HTML (e.g., associated with the text/html Content-Type header field), a structured content type (e.g., the Java Script Object Notation (JSON) content type, which is associated with the application/json Content-Type header field; the Extensible Markup Language (XML) content type, which is associated with the application/xml Content-Type header field; and/or the like), an image content type (e.g., a Joint Photographic Experts Group (JPEG) content type, which is associated with image/jpeg Content-Type header field), a video content type (e.g., an MP4 content type, which is associated with the video/mp4 Content-Type header field), and/or the like.

In some cases, the preprocessor 122 may determine the suitable preprocessing operation(s) for a network traffic packet based on the protocol, content type, and/or other categorical attribute associated with the packet. For example, in some cases, when the preprocessor 122 determines that a network traffic packet represents encrypted data (e.g., HTTPS packet(s)), the system may decrypt the encrypted data. In some cases, to determine whether a network traffic packet is an HTTPS packet, the preprocessor 122 may process the packet header to identify the destination port number. For example, the preprocessor 122 may determine that a network traffic packet is an HTTPS packet when the destination port number is “443”, which is the standard port number for HTTPS communication. In some cases, the preprocessor 122 may process the packet payload to identify specific patterns and/or keywords that indicate that the packet is an HTTPS packet. For example, the preprocessor 122 may identify an HTTPS packet based on the presence of specific keywords in the payload (e.g., “TLS”, “SSL”, and/or the like). In some cases, the preprocessor 122 may use deep packet inspection techniques to process the packet payload and identify characteristics that indicate that the packet is an HTTPS packet.

As another example, in some cases, when the preprocessor 122 determines that a network traffic packet includes HTML data, the preprocessor 122 may determine to remove image data and/or random sequence data from the network traffic data. In some cases, to detect image data within the HTML data, the system may extract data associated with one or more HTML tags (e.g., <img> tags, <picture> tags, <embed> tags, <object> tags, <canvas> tags, and/or the like). For example, in some cases, the system may extract the src attribute of an <img> tag to identify the URL of an image. In some cases, the system may identify base64-encoded image data embedded within an <img> tag (e.g., within the src attribute of the <img> tag). In some cases, the system may identify image data embedded within other tags, such as within a <picture> tag, an <embed> tag, an <object> tag, a <canvas> tag, and/or the like. In some cases, the system may identify image data based on file extensions (e.g.,.jpg,.png,.gif, and/or the like). In some cases, the system may identify image data based on presence of one or more corresponding Content-Type header fields (e.g., “image/jpeg”, “image/png”, and/or the like).

As another example, in some cases, when the preprocessor 122 determines that a network traffic packet includes an authentication request, the preprocessor 122 may determine to remove and/or replace unique identifiers with default tokens. In some cases, to determine whether a network traffic packet includes an authentication request, the preprocessor 122 may process the content of the packet to identify specific keywords, patterns, and/or the like. For example, the preprocessor 122 may identify an authentication request based on the presence of specific HTTP methods (e.g., POST requests sent to login pages), specific URLs (e.g., URLs containing “login”, “auth”, “signin”, and/or the like), specific keywords in the payload of the packet (e.g., “username”, “password”, “token”, “auth_key”, and/or the like), specific header fields (e.g., an “Authorization” header), and/or the like. In some cases, the preprocessor 122 may use regular expressions to identify patterns in the network traffic packet that indicate an authentication request. In some cases, the preprocessor 122 may use machine learning models to classify network traffic packets as authentication requests.

As another example, in some cases, when the preprocessor 122 determines that a network traffic packet represents form data (e.g., responses to one or more form inquiries), the preprocessor 122 may preserve the form data as part of the preprocessed packet. In some cases, to determine whether a network packet includes form data, the system may determine whether a content type represented by the packet's header (e.g., by the Content-Type header field of an HTTP packet) represents that the network packet includes form data. For example, in some cases, if the Content-Type header field of an HTTP packet is one of application/x-www-form-urlencoded or multipart/form-data, the system may determine that the network packet includes form data. In some cases, the system may process the payload of the packet to identify specific patterns and/or keywords that indicate that the packet includes form data. For example, the system may identify form data based on the presence, in the packet's payload, of key-value pairs, field names, and/or the like.

As another example, in some cases, when the preprocessor 122 determines that a network traffic packet represents a TCP/IP packet, the preprocessor 122 may determine to remove particular lower-level header data from the network traffic data. A lower-level header may refer to at least one of a Layer 1 header (e.g., a physical layer header), a Layer 2 header (e.g., a data link layer header), and/or the like. A physical layer header may include information about the physical transmission of the data, such as the physical addresses of the sender and receiver, the type of physical medium used for transmission (e.g., copper cable, fiber optic cable, and/or the like), error detection codes, and/or the like. A data link layer header may include information about the logical link between the sender and receiver, such as the MAC addresses of the sender and receiver, the type of data link protocol used (e.g., Ethernet, Wi-Fi, and/or the like), error detection codes, and/or the like. Removing lower-level header data may reduce the size of the network traffic data and/or may remove information that are not expected to be semantically relevant to the prediction task.

The language model 124 may be configured to process the preprocessed network traffic data to generate an encoded representation. The language model 124 may be a transformer model with an attention-based mechanism. The language model 124 may be trained on a large dataset of network traffic data. The language model 124 may generate different types of encoded representations (e.g., embeddings, vector representations, and/or the like). Alternatively, or additionally, the language model 124 may be configured to generate outputs in addition to and/or other than encoded representations. For example, in some cases, the language model 124 may generate one or more of generative outputs (e.g., textual descriptions and/or summaries of the network traffic data), classifications (e.g., classifications of the network traffic data into different categories, classifications of network traffic data as being associated with malicious activity patterns, and/or the like), and/or the like.

In some cases, the language model 124 may generate an output (e.g., an encoded representation, generative output, classification, and/or the like) based on the network traffic data (e.g., packets) associated with a connection session. For example, in some cases, the language model 124 may: (i) determine that a set of packets relate to the same communication session (e.g., using the techniques described below), (ii) preprocess the set of packets, and (iii) process the preprocessed packets collectively to generate an output. In some cases, the language model 124 may determine that a set of packets are associated with the same session based on the presence of the same session identifier (e.g., cookie identifier) in those packets. In some cases, the system may use other techniques to identify network traffic packets associated with a connection session, such as based on commonality of source and destination IP addresses of the packets, commonality of port numbers associated with the network traffic packets, temporal proximity of the timestamps associated with the packets, and/or the like.

In some cases, the system may use the generative output of the language model 124 to predict (e.g., in real-time and/or near-real-time) a simulated future request by a device based on past request(s) indicated by past network packet(s) received from the device and predict whether the simulated future behavior represents malicious activity and execute the preventive actions. For example, the system may: (i) receive network traffic data associated with one or more past requests by a device, (ii) preprocess the network traffic data, (iii) process the preprocessed network traffic data using the language model 124 to generate a generative output representing a simulated future request by the device, (iv) determine whether the simulated future request represents a malicious activity, and/or (v) if the simulated future request represents a malicious activity, perform a preventive action. In some cases, the system may determine whether the simulated future request represents a malicious activity based on one or more rules. The rules may, for example, specify one or more criteria (e.g., the type of request, the target of the request, the timing of the request, and/or the like) and one or more actions to be taken when the criteria are met (e.g., block the request, log the request, generate an alert, and/or the like).

In some cases, the system may determine whether the simulated future request represents a malicious activity by: (i) preprocessing the simulated future request, (ii) processing the simulated future request using the language model 124 to generate an encoded representation, and/or (iii) processing the encoded representation using the prediction model 126 to generate a prediction about whether the simulated future request represents a malicious activity. For example, the system may preprocess the simulated future request using the same preprocessing operations that were used to preprocess the network traffic data associated with the one or more past requests. The system may then process the preprocessed simulated future request using the language model 124 to generate an encoded representation. The system may then process the encoded representation using the prediction model 126 to generate a prediction about whether the simulated future request represents a malicious activity. The prediction may, for example, be a probability score, a categorical output, and/or the like.

In some cases, if the system determines that the simulated future request represents a malicious activity, the system may perform a preventive action. A preventive action may refer to at least one of: (i) presenting a CAPTCHA challenge to the device, (ii) prompting the user of the device to re-authenticate, (iii) throttling the rate of requests from the device, (iv) temporarily suspending the device's access to the server component(s) 118, (v) redirecting the device to a warning page, (vi) increasing the monitoring level for the device, (vii) initiating an enhanced authentication process for the device (e.g., requiring multi-factor authentication), and/or the like.

The prediction model 126 may be configured to process an encoded representation generated by the language model 124 to generate a predicted feature. The prediction model 126 may be a classification model. The prediction model 126 may be trained on a labeled dataset of encoded representations and corresponding features. The prediction model 126 may generate different types of predicted features (e.g., probability scores, categorical outputs, and/or the like).

The training component 112 may include one or more software applications configured to train the language model 124 and the prediction model 126 (e.g., using the techniques described above). The training component 112 may access historic data 114 and label data 116 to train the language model 124 and the prediction model 126. The historic data 114 may include a collection of network traffic data. The label data 116 may include labels associated with the network traffic data (e.g., indicating whether the network traffic data represents a malicious activity pattern). Example techniques for training the language model 124 and the prediction model 126 based on network traffic data and/or labels associated with network traffic data are described above.

The server component(s) 118 may include one or more software applications configured to provide one or more services (e.g., web services, APIs, and/or the like) to the client(s) 102. The server component(s) 118 may use the language model 124 and the prediction model 126 to perform predictions on network traffic data. The server component(s) 118 may be configured to receive network traffic data from the network monitoring component(s) 110.

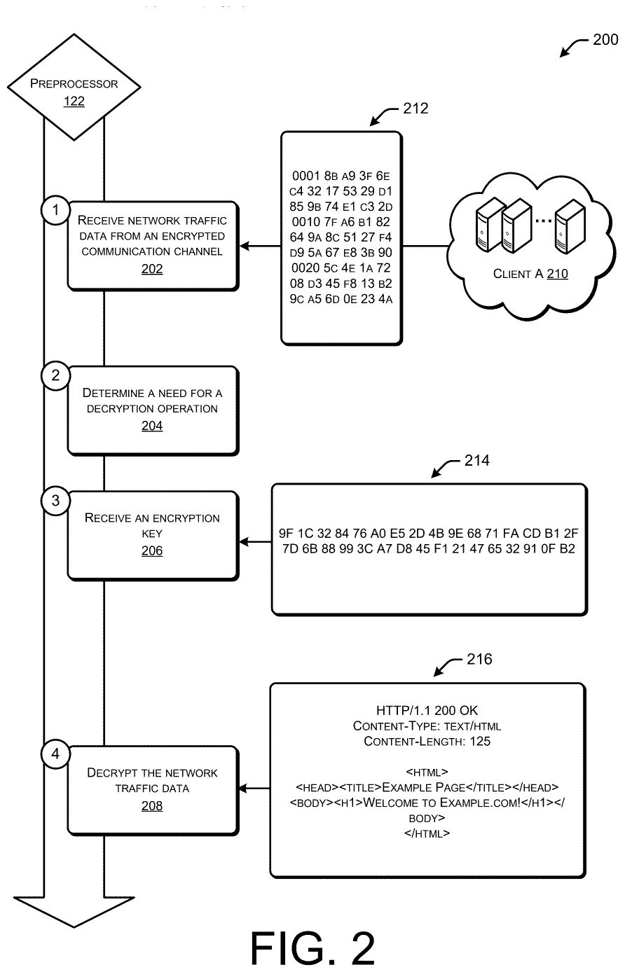

FIG. 2 is a flowchart diagram of an example process 200 for preprocessing network traffic data using decryption-based techniques. As depicted in FIG. 2, at operation 202, the preprocessor 122 receives network traffic data using an encrypted communication channel (e.g., an HTTPS channel). For example, as depicted in FIG. 2, the preprocessor 122 receives the packet 212 from the client 210. The packet 212 may, for example, include one or more encrypted portions (e.g., an encrypted payload). The packet 212 may, for example, be an HTTPS packet. The packet 212 may, for example, include one or more header fields indicating that the packet is encrypted (e.g., by setting a flag in a TCP header).

At operation 204, the preprocessor 122 determines a need for performing a decryption preprocessing operation on the received network traffic data. For example, the system may determine a need for the decryption operation based on determining that the received network traffic data is associated with an encrypted communication channel. Example techniques for determining that particular network traffic data (e.g., a particular received packet) is associated with an encrypted communication channel are described above. For example, the preprocessor 122 may determine that the packet 212 is associated with an encrypted communication channel based on a port number associated with the packet 212 (e.g., port number “443”). As another example, the preprocessor 122 may determine that the packet 212 is associated with an encrypted communication channel based on a header field included in the packet 212.

At operation 206, the preprocessor 122 receives an encryption key (e.g., an HTTPS session key) associated with the encrypted communication channel. An example of an encryption key 214 is provided in FIG. 2. In some cases, the preprocessor 122 may receive the encryption key from a key store. The key store may, for example, represent a database, a file, and/or the like storing encryption keys associated with different encrypted communication channels. In some cases, the key store is maintained by the network monitoring component(s) 110. In some cases, the key store is maintained by another component and/or system. For example, the encryption key may be a symmetric key, an asymmetric key, and/or the like. The encryption key may, for example, be associated with a specific session, a specific user, a specific device, and/or the like. In some cases, the preprocessor 122 receives the encryption key from the client 210. In some cases, the preprocessor 122 receives the encryption key from the server component(s) 118. In some cases, the preprocessor 122 generates the encryption key based on one or more predetermined parameters.

At operation 208, the preprocessor 122 decrypts the network traffic data using the received encryption key. For example, as depicted in FIG. 2, the preprocessor 122 may generate the decrypted network packet 216 based on decrypting the packet 212 in accordance with the encryption key 214. In some cases, the preprocessor 122 may decrypt the packet 212 using a decryption algorithm (e.g., an Advanced Encryption Standard (AES) decryption algorithm, a Rivest-Shamir-Adleman (RSA) decryption algorithm, and/or the like). The decryption algorithm may, for example, be selected based on the type of encryption used for the encrypted communication channel. The decrypted network traffic data may, for example, include one or more decrypted portions (e.g., a decrypted payload). The decrypted network traffic data may, for example, be used for further processing (e.g., by the language model 124 and/or the prediction model 126).

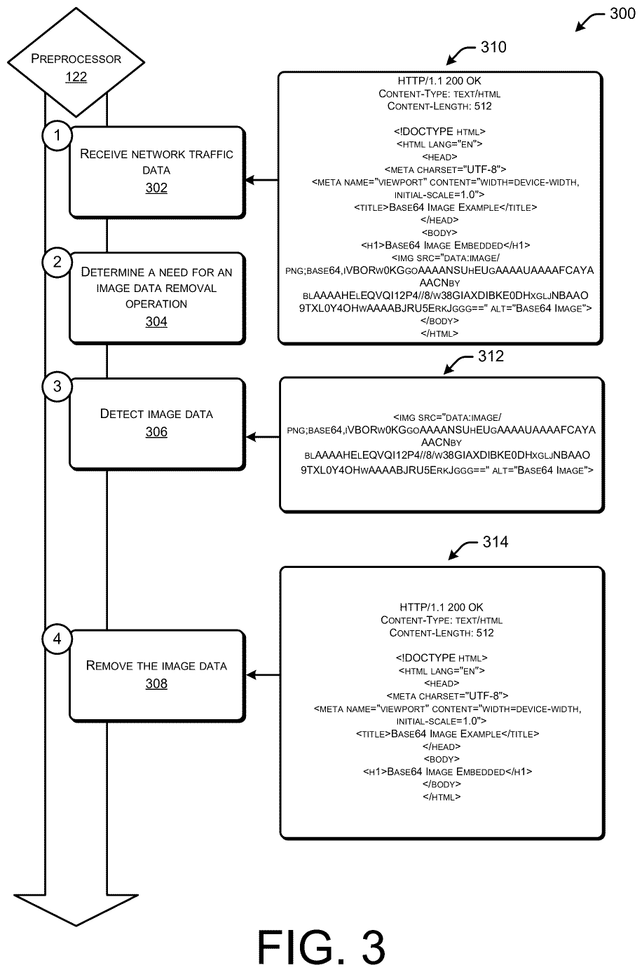

FIG. 3 is a flowchart diagram of an example process 300 for preprocessing network traffic data using an image data removal operation. As depicted in FIG. 3, at operation 302, the preprocessor 122 receives network traffic data (e.g., the packet 310). The network traffic data may, for example, an HTTP network packet.

At operation 304, the preprocessor 122 determines a need for a preprocessing operation for image data removal. In some cases, the preprocessor 122 may determine a need for the image data removal operation based on determining that the received network traffic data includes HTML data and that the HTML data includes image data. For example, the preprocessor 122 may determine that the network traffic data includes HTML data based on the content type of the network traffic data (e.g., the preprocessor 122 may determine that the network traffic data includes HTML data when the Content-Type header field of an HTTP packet is text/html). As another example, the preprocessor 122 may determine that the network traffic data includes HTML data based on the presence of specific keywords and/or tags in the network traffic data (e.g., the preprocessor 122 may determine that the network traffic data includes HTML data when the network traffic data includes one or more of the <html>, <head>, <title>, <body>, <h1>through <h6>, <p>, <br>, <a>, <img>, <ul>, <ol>, <li>, and/or <div> tags).

At operation 306, the preprocessor 122 detects image data (e.g., image data 312) in the network traffic data. Example techniques for identifying image data in HTML data are described above. For example, the preprocessor 122 may detect image data based on the presence of specific HTML tags (e.g., <img> tags, <picture> tags, <embed> tags, <object>tags, <canvas> tags, and/or the like). As another example, the preprocessor 122 may detect image data based on file extensions (e.g.,.jpg,.png,.gif, and/or the like). As another example, the preprocessor 122 may detect image data based on HTTP Content-Type header fields (e.g., “image/jpeg”, “image/png”, and/or the like).

At operation 308, the preprocessor 122 generates preprocessed network traffic data (e.g., the preprocessed packet 314) based on removing at least the detected image data from the network traffic data. For example, the preprocessor 122 may remove the image data by deleting the image data from the network traffic data. As another example, the preprocessor 122 may remove the image data by replacing the image data with a placeholder value (e.g., a blank space, a default token, and/or the like). The preprocessed network traffic data may, for example, be used for further processing (e.g., by the language model 124 and/or the prediction model 126).

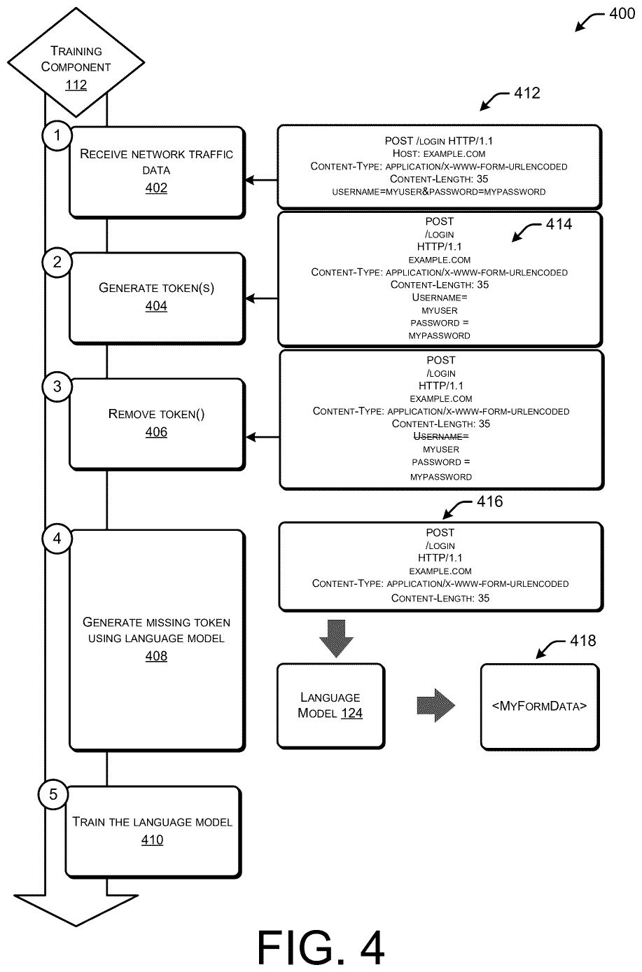

FIG. 4 is a flowchart diagram of an example process 400 for training the language model 124. As depicted in FIG. 4, at operation 402, the training component 112 receives a network traffic data. For example, as depicted in FIG. 4, the training component 112 receives the packet 412.

At operation 404, the training component 112 generates a set of tokens based on the received network traffic data. For example, as depicted in FIG. 4, the training component 112 may generate the set of tokens 414 based on the packet 412.

At operation 406, the training component 112 removes (e.g., masks) a subset of the generated tokens. For example, as depicted in FIG. 4, the training component 112 removes the token “username.”

At operation 408, the training component 112 generates a predicted token value for the removed token. In some cases, the training component 112 provides input data determined based on a non-removed subset of the tokens to the language model 124. For example, as depicted in FIG. 4, the training component 112 provides the input data 416, which includes a subset of the non-removed tokens before the removed token “username”, to the language model 124. The language model 124 may, for example, generate a predicted token value 418 based on the input data 416. For example, the language model 124 may process the input data 416 to generate a prediction for the removed token based on the input data 416. The prediction may, for example, be a probability distribution over the vocabulary of the language model 124. The predicted token value 418 may, for example, be the token with the highest probability in the probability distribution.

At operation 410, the training component 112 trains the language model 124 based on the generated predicted token value. For example, the training component 112 may determine a loss based on a difference (e.g., a cross-entropy loss) between the generated predicted token value and an actual token value corresponding to the removed token. The training component 112 may, for example, use the determined loss to update one or more parameters of the language model 124. The training component 112 may, for example, use an optimization algorithm (e.g., a stochastic gradient descent (SGD) algorithm, an Adam optimization algorithm, and/or the like) to update the parameters of the language model 124. The training component 112 may, for example, repeat operations 402-410 for a plurality of network traffic data to train the language model 124.

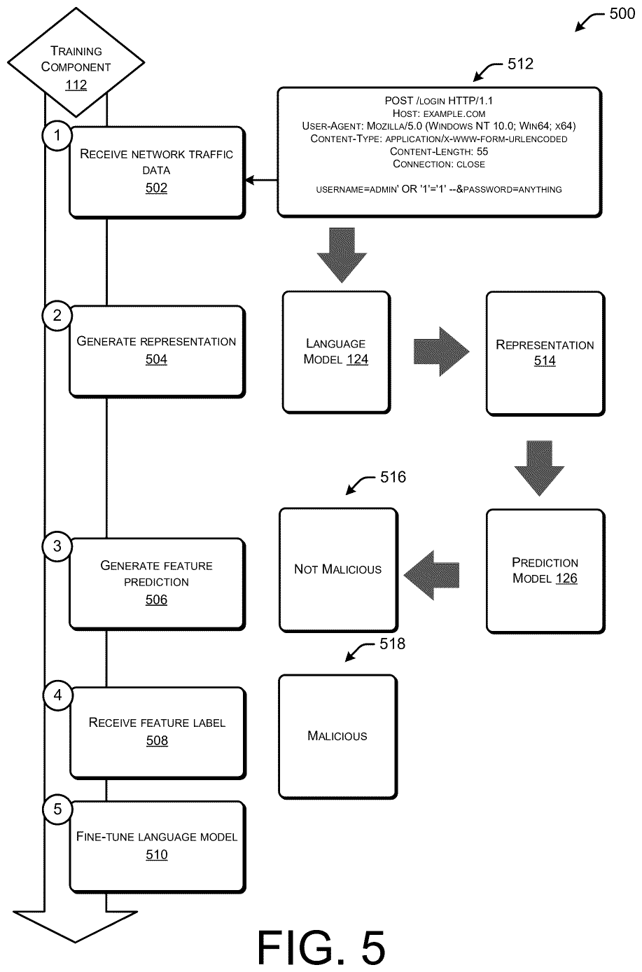

FIG. 5 is a flowchart diagram of an example process 500 for training the language model 124. As depicted in FIG. 5, at operation 502, the training component 112 receives network traffic data. For example, as depicted in FIG. 5, the training component 112 may receive the packet 512.

At operation 504, the training component 112 generates an encoded representation of the network traffic data using the language model 124. For example, as depicted in FIG. 5, the language model 124 may generate the encoded representation 514 of the packet 512. In some cases, the training component 112 may preprocess the network traffic data (e.g., using the preprocessor 122) and provide the preprocessed network traffic data as input to the language model 124. The language model 124 may generate an encoded representation of the preprocessed network traffic data. The encoded representation may, for example, be a vector representation, an embedding, and/or the like.

At operation 506, the training component 112 generates a predicted feature based on processing the encoded representation using the prediction model 126. For example, as depicted in FIG. 5, the prediction model 126 may generate the predicted feature 516. As depicted in FIG. 5, the predicted feature 516 represents that the packet 512 is predicted to not exhibit malicious activity pattern(s). In some cases, the training component 112 may provide the encoded representation as input to the prediction model 126. The prediction model 126 may generate a predicted feature based on the encoded representation. The predicted feature may, for example, be a probability score, a categorical output, and/or the like.

At operation 508, the training component 112 receives a labeled feature associated with the network traffic data. For example, as depicted in FIG. 5, the training component 112 may receive the labeled feature 518, which represents that the packet 512 is predicted to exhibit malicious activity pattern(s). In some cases, the training component 112 may receive the labeled feature from the label data 116. The labeled feature may, for example, indicate whether the network traffic data represents a malicious activity.

At operation 510, the training component 112 fine-tunes the language model 124 based on the labeled feature and the predicted feature. For example, the training component 112 may determine a loss based on a difference between the predicted feature and the labeled feature. The training component 112 may use the determined loss to update one or more parameters of the language model 124. The training component 112 may, for example, use an optimization algorithm (e.g., an SGD algorithm, an Adam optimization algorithm, and/or the like) to update the parameters of the language model 124. The training component 112 may, for example, repeat operations 502-510 for a plurality of network traffic data to fine-tune the language model 124.

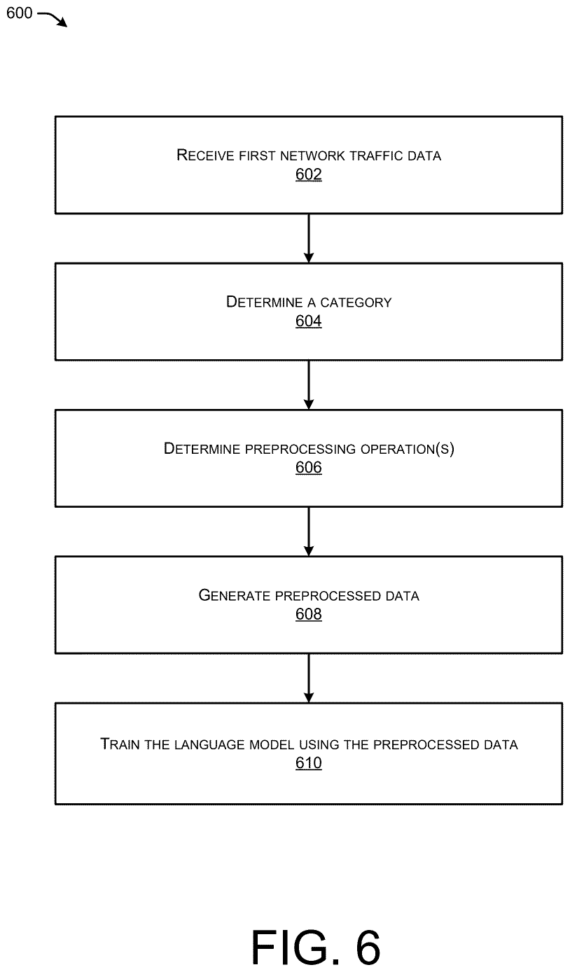

FIG. 6 is an example process 600 for training a language model based on preprocessed network traffic data. As depicted in FIG. 6, at operation 602, an example system (e.g., the training component 112) receives network traffic data. The network traffic data may, for example, include one or more network packets, network flows, network logs, and/or the like. The network traffic data may, for example, be associated with one or more communication protocols (e.g., HTTP, HTTPS, FTP, SMTP, DNS, Telnet, and/or the like).

At operation 604, the system determines a category associated with the network traffic data. A category may refer to a protocol and/or a content type associated with the network traffic data. Example protocols and content types are described above. For example, the system may determine the category based on processing one or more header fields of the network traffic data. As another example, the system may determine the category based on processing a payload of the network traffic data.

At operation 606, the system determines one or more preprocessing operations to perform on the network traffic data. The system may, for example, determine the one or more preprocessing operations based on the category determined at operation 604. Example preprocessing operations and example techniques for determining which preprocessing operations to perform based on a category associated with network traffic data are described above.

At operation 608, the system generates preprocessed network traffic data based on the one or more preprocessing operations. For example, the system may generate the preprocessed network traffic data by performing the one or more preprocessing operations on the network traffic data.

At operation 610, the system trains the language model (e.g., the language model 124) using the preprocessed network traffic data. For example, the system may train the language model using one or more language modeling tasks, such as a missing token prediction task, a next sentence prediction task, a masked language modeling task, and/or the like. Example language modeling tasks and example techniques for training the language model based on language modeling tasks are described above.

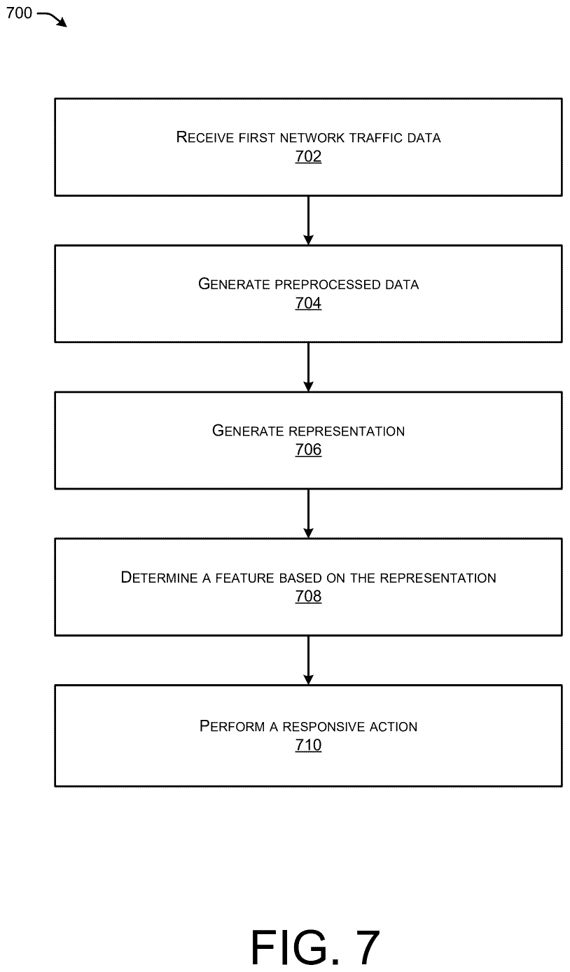

FIG. 7 is a flowchart diagram of an example process 700 for generating predictions based on preprocessed network traffic data. As depicted in FIG. 7, at operation 702, an example system (e.g., the server component(s) 118) receives network traffic data. The network traffic data may, for example, include one or more network packets, network flows, network logs, and/or the like. The network traffic data may, for example, be associated with one or more communication protocols (e.g., HTTP, HTTPS, FTP, SMTP, DNS, Telnet, and/or the like).

At operation 704, the system generates preprocessed network traffic data based on the received network traffic data. For example, the system may generate the preprocessed network traffic data by performing one or more preprocessing operations on the received network traffic data. Example preprocessing operations are described above. In some cases, the system performs the one or more preprocessing operations using the preprocessor 122.

At operation 706, the system generates a representation based on the preprocessed network traffic data. For example, the system may generate the representation by providing the preprocessed network traffic data as input to the language model 124. The representation may, for example, include one or more of an encoded representation, a generative output, and/or the like. Example encoded representations and example generative outputs are described above.

At operation 708, the system determines a feature based on the representation. For example, the system may determine the feature by providing the representation as input to the prediction model 126. The feature may, for example, include one or more of a classification, a probability score, and/or the like.

At operation 710, the system performs a responsive action based on the feature. For example, if the feature indicates that the network traffic data represents a malicious activity, the system may perform a responsive action, such as blocking the network traffic data, logging the network traffic data, generating an alert, and/or the like. Example responsive actions are described above.

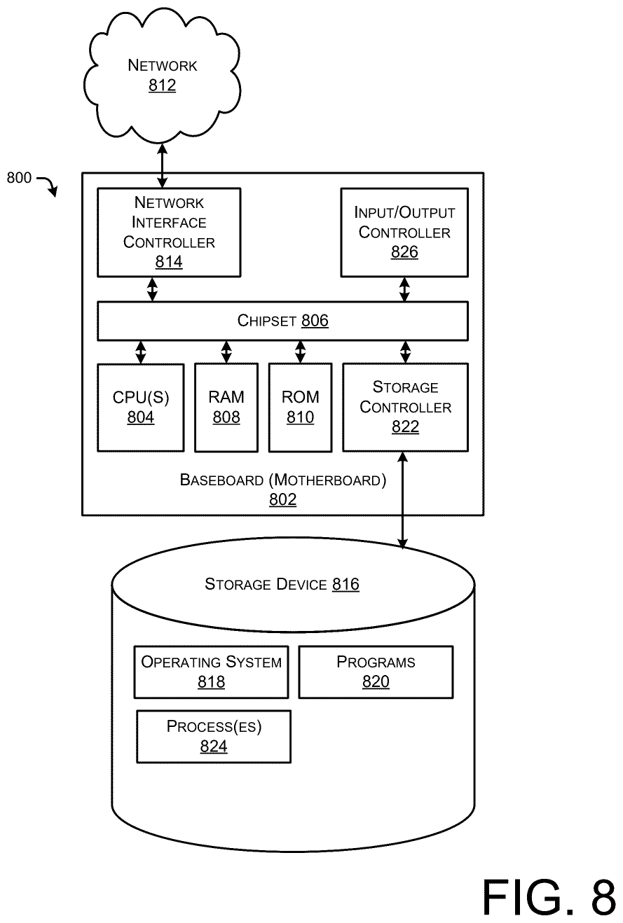

FIG. 8 shows an example computer architecture for a computer 800 capable of executing program components for implementing the functionality described above. The computer architecture shown in FIG. 8 illustrates a conventional server computer, workstation, desktop computer, laptop, tablet, network appliance, e-reader, smartphone, or other computing device, and can be utilized to execute any of the software components presented herein. The computer 800 may, in some examples, correspond to a network node (e.g., the 8) described herein.

The computer 800 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a random-access memory (RAM) 808, used as the main memory in the computer 800. The chipset 806 can further provide an interface to a computer-readable storage medium such as a read-only memory (ROM) 810 or non-volatile RAM (NVRAM) for storing basic routines that help to start up the computer 800 and to transfer information between the various components and devices. The ROM 810 or NVRAM can also store other software components necessary for the operation of the computer 800 in accordance with the configurations described herein.

The computer 800 can operate in a networked environment using logical connections to remote computing devices and computer systems through a network, such as the network 812. The chipset 806 can include functionality for providing network connectivity through a network interface controller (NIC) 814, such as a gigabit Ethernet adapter. The NIC 814 is capable of connecting the computer 800 to other computing devices over the network 812. It should be appreciated that multiple NICs 814 can be present in the computer 800, connecting the computer 800 to other types of networks and remote computer systems. In some instances, the NICs 814 may include at least on ingress port and/or at least one egress port.

The computer 800 can be connected to a storage device 816 that provides non-volatile storage for the computer. The storage device 816 can store an operating system 818, programs 820, and data, which have been described in greater detail herein. The storage device 816 can be connected to the computer 800 through a storage controller 822 connected to the chipset 806. The storage device 816 can consist of one or more physical storage units. The storage device 816 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 800 can store data on the storage device 816 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 816 is characterized as primary or secondary storage, and the like.

For example, the computer 800 can store information to the storage device 816 by issuing instructions through the storage controller 822 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 can further read information from the storage device 816 by detecting the physical states or characteristics of one or more particular locations within the physical storage units.

In addition to the mass storage device 816 described above, the computer 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 800. In some examples, the operations performed by any network node described herein may be supported by one or more devices similar to computer 800. Stated otherwise, some or all of the operations performed by a network node may be performed by one or more computers 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 816 can store an operating system 818 utilized to control the operation of the computer 800. According to one embodiment, the operating system comprises the LINUX™ operating system. According to another embodiment, the operating system includes the WINDOWS™ SERVER operating system from MICROSOFT Corporation of Redmond, Washington. According to further embodiments, the operating system can comprise the UNIX™ operating system or one of its variants. It should be appreciated that other operating systems can also be utilized. The storage device 816 can store other system or application programs and data utilized by the computer 800.

In one embodiment, the storage device 816 or other computer-readable storage media is encoded with computer-executable instructions which, when loaded into the computer 800, transform the computer from a general-purpose computing system into a special-purpose computer capable of implementing the cases described herein. These computer-executable instructions transform the computer 800 by specifying how the CPUs 804 transition between states, as described above. According to one embodiment, the computer 800 has access to computer-readable storage media storing computer-executable instructions which, when executed by the computer 800, perform the various processes described above with regard to FIGS. 1-7. The computer 800 can also include computer-readable storage media having instructions stored thereupon for performing any of the other computer-implemented operations described herein.

As illustrated in FIG. 8, the storage device 816 stores programs 820, which may include one or more processes 824. The process(es) 824 may include instructions that, when executed by the CPU(s) 804, cause the computer 800 and/or the CPU(s) 804 to perform one or more operations.

The computer 800 can also include at least one input/output controller 826 for receiving and processing input from a number of input devices, such as a keyboard, a mouse, a touchpad, a touch screen, an electronic stylus, or other type of input device. Similarly, an input/output controller 826 can provide output to a display, such as a computer monitor, a flat-panel display, a digital projector, a printer, or other type of output device. It will be appreciated that the computer 800 might not include all of the components shown in FIG. 8, can include other components that are not explicitly shown in FIG. 8, or might utilize an architecture completely different than that shown in FIG. 8.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving first network traffic data associated with a first computing device;
determining a category associated with the first network traffic data, wherein the category represents at least one of a protocol or a content type;
determining first preprocessed data based on the first network traffic data and a preprocessing operation, wherein the preprocessing operation is determined based on the category;
training a machine learning model based on the first preprocessed data and a language modeling task; and
providing the machine learning model to a system, wherein the system is configured to determine a feature associated with second network traffic data based on the machine learning model.

2. The method of claim 1, wherein the preprocessing operation comprises:
determining, based on the protocol represented by the category, that the first network traffic data comprises encrypted data; and
filtering the first network traffic data based on at least one of:
decrypting at least a portion of the encrypted data, or
removing at least a portion of the encrypted data.

3. The method of claim 1, wherein the preprocessing operation comprises:
determining, based on the content type represented by the category, that the first network traffic data comprises hyper-text markup language (HTML) data;
determining that the HTML data comprises image data; and
filtering the first network traffic data based on removing the image data.

4. The method of claim 1, wherein the preprocessing operation comprises:
determining, based on the content type represented by the category, that the first network traffic data comprises form data; and
filtering the first network traffic data based on preserving at least a portion of the form data.

5. The method of claim 1, wherein the preprocessing operation comprises:
determining, based on the category, that the first network traffic data is associated with an authentication request to an application programming interface (API); and
filtering the first network traffic data based on preserving at least a portion of authentication data associated with the authentication request.

6. The method of claim 1, wherein training the machine learning model comprises:
determining, based on the first preprocessed data and using the machine learning model, a representation associated with the first preprocessed data;
determining, based on the representation, a predicted token of the first preprocessed data;
determining a loss based on the predicted token; and
training the machine learning model based on the loss.

7. The method of claim 6, wherein training the machine learning model further comprises:
determining a predicted feature associated with the first preprocessed data based on the representation;
determining a second loss based on the predicted feature and a labeled feature; and
training the machine learning model based on the second loss.

8. The method of claim 1, wherein the system is configured to:
determine that the second network traffic data is associated with a connection session, the connection session being associated with a plurality of network traffic data packets; and
determine the feature based on the plurality of network traffic data packets.

9. The method of claim 8, wherein the feature represents a simulated future behavior associated with the connection session.

10. The method of claim 1, wherein the method is executed by at least one of a firewall, an intrusion detection system, or an intrusion prevention system.

11. The method of claim 1, wherein the feature represents that the first network traffic data represents malicious activity, and wherein the system is configured to perform one or more responsive actions based on the feature.

12. A system comprising:
one or more processors; and
one or more non-transitory computer-readable media storing computer-executable instructions that, when executed, cause the system to perform operations comprising:
receiving first network traffic data associated with a first computing device;
determining a category associated with the first network traffic data, wherein the category represents at least one of a protocol or a content type;
determining first preprocessed data based on the first network traffic data and a preprocessing operation, wherein the preprocessing operation is determined based on the category;
training a machine learning model based on the first preprocessed data and a language modeling task; and
providing the machine learning model to a second system, wherein the second system is configured to determine a feature associated with second network traffic data based on the machine learning model.

13. The system of claim 12, wherein the preprocessing operation comprises:
determining, based on the protocol represented by the category, that the first network traffic data comprises encrypted data; and
filtering the first network traffic data based on at least one of:
decrypting at least a portion of the encrypted data, or
removing at least a portion of the encrypted data.

14. The system of claim 12, wherein the preprocessing operation comprises:
determining, based on the content type represented by the category, that the first network traffic data comprises hyper-text markup language (HTML) data;
determining that the HTML data comprises image data; and
filtering the first network traffic data based on removing the image data.

15. The system of claim 12, wherein the preprocessing operation comprises:
determining, based on the content type represented by the category, that the first network traffic data comprises form data; and
filtering the first network traffic data based on preserving at least a portion of the form data.

16. The system of claim 12, wherein the preprocessing operation comprises:
determining, based on the category, that the first network traffic data is associated with an authentication request to an application programming interface (API); and
filtering the first network traffic data based on preserving at least a portion of authentication data associated with the authentication request.

17. One or more non-transitory computer-readable media storing instructions executable by one or more processors, wherein the instructions, when executed, cause the one or more processors to perform operations comprising:
receiving first network traffic data associated with a first computing device;
determining a category associated with the first network traffic data, wherein the category represents at least one of a protocol or a content type;
determining first preprocessed data based on the first network traffic data and a preprocessing operation, wherein the preprocessing operation is determined based on the category;
training a machine learning model based on the first preprocessed data and a language modeling task; and
providing the machine learning model to a system, wherein the system is configured to determine a feature associated with second network traffic data based on the machine learning model.

18. The one or more non-transitory computer-readable media of claim 17, wherein the preprocessing operation comprises:
determining, based on the protocol represented by the category, that the first network traffic data comprises encrypted data; and
filtering the first network traffic data based on at least one of:
decrypting at least a portion of the encrypted data, or
removing at least a portion of the encrypted data.

19. The one or more non-transitory computer-readable media of claim 17, wherein the preprocessing operation comprises:
determining, based on the content type represented by the category, that the first network traffic data comprises hyper-text markup language (HTML) data;
determining that the HTML data comprises image data; and
filtering the first network traffic data based on removing the image data.

20. The one or more non-transitory computer-readable media of claim 17, wherein the preprocessing operation comprises:
determining, based on the content type represented by the category, that the first network traffic data comprises form data; and
filtering the first network traffic data based on preserving at least a portion of the form data.
